(19) United States
(12) Patent Application Publication
(10) Pub. No.: US 2014/0009990 A1
(43) Pub. Date: Jan. 9, 2014

(54) METHOD AND APPARATUS FOR CHARACTERIZING POWER SUPPLY IMPEDANCE FOR POWER DELIVERY NETWORKS

(71) Applicants: Sanat Kapoor, San Diego, CA (US); Christopher F. Einsmann, San Diego, CA (US); Alfonso T. Trujillo, San Diego, CA (US)

(72) Inventors: Sanat Kapoor, San Diego, CA (US); Christopher F. Einsmann, San Diego, CA (US); Alfonso T. Trujillo, San Diego, CA (US)

(73) Assignee: QUALCOMM INCORPORATED, San Diego, CA (US)

(21) Appl. No.: 13/544,483

(22) Filed: Jul. 9, 2012

(51) Int. Cl. H02M 5/02

(52) U.S. Cl. 363/165

(57) ABSTRACT

A method and apparatus for generating an arbitrary current waveform for use in characterizing power supply impedance for power delivery networks are provided. The method begins by providing an arbitrary waveform as an input to a test circuit. The current and voltage at an output of a device under test in then examined A frequency is then swept through a pre-determined range; and the frequency of the arbitrary voltage waveform is changed to match a predetermined frequency and impedance point.

### BACKGROUND

1. Field

The present disclosure relates generally to power delivery networks, and more particularly, to a method an apparatus to generate an arbitrary load current waveform and characterize the impedance of a power delivery network with an active power supply.

2. Background

Wireless phones and other devices have gained in popularity as they have gained in capability. “Smart phones” are becoming increasingly widespread and are used for web searches as well as sending and receiving email while on the go. These developments have been made possible through the use of high speed microprocessors. Such high speed microprocessors require that a power delivery system be designed to hold a very steady voltage even when experiencing large transient currents. Typically, this has been done in the frequency domain by specifying the impedance over frequency. This provides a measure of the amount of deviation in the voltage and permits analysis of how the voltage deviates under varying loading conditions. The need for testing arises because high speed processors have very stringent power delivery network (PDN) impedance requirements and characterizing the impedance of a power supply and PDN on an actual printed circuit board has proven difficult.

The power delivery system may be comprised of an active voltage source, such as a switched mode power supply (SMPS) low dropout regulator (LDO), or a battery, and may also include passive interconnects and decoupling components. While it is possible to measure and characterize the passive portion of the system using a network analyzer, it is not possible to measure and characterize for the active voltage source in the system. With today's digital circuits, the transient performance of the power supply is frequently the limiting factor at the lower end of the spectrum.

In the past characterizing the impedance of a power supply and a PDN on an actual printed wiring board (PWB) has proven difficult. Simulation has been tried, but does not produce a true measurement. A power network analyzer may also be used, but is suited to small signal measurements only. Another alternative is to use an off-the-shelf electronic load, however, this has limited capabilities, and may be large as well as expensive. A transistor may be used to emulate load current, but lacks accuracy and does not provide good control over the load current.

Aspects of a PDN need to be characterized in order to ensure optimum performance under a variety of load conditions. Components comprising the PDN affect the characterization, especially processors with optimized profiles for a power delivery network. In such cases, the circuit is incorporated into an application specific integrated circuit (ASIC) for self-calibrating PDNs. The PDN is characterized separately and is then input to the ASIC as a look-up table. Voltage regulators may also be characterized. The characterization process includes emulating load currents for testing.

There is a need in the art for a method and apparatus for accurately characterizing the performance of the PDN used to supply voltage to a high speed microprocessor in order to ensure optimum performance under a variety of load conditions.

### SUMMARY

Embodiments disclosed herein provide a method for generating an arbitrary current waveform for use in characterizing power supply impedance for power delivery networks. The method begins by providing an arbitrary waveform as an input to a test circuit. The current and voltage at an output of a device under test in then examined. A frequency is then swept through a pre-determined range; and the frequency of the arbitrary voltage waveform is changed to match a predetermined frequency and impedance point.

A further embodiment provides a method for generating an arbitrary current waveform. The method begins when an arbitrary voltage waveform is provided as an input to a test circuit. The current and voltage of a device under test are then examined at an output of the device. A frequency is then swept through a predetermined range. While the current is being swept through the predetermined range voltage and current values are collected at pre-selected frequencies within a desired range. The collection process is repeated to produce an impedance over frequency plot for the test circuit.

Yet a further embodiment provides an apparatus for generating an arbitrary current waveform. The apparatus includes: a load current generator, wherein the load current generator includes a first battery connected to a ground of a device under test, a system, ground and a battery. The apparatus also includes a variable resistor, a virtual ground, and a power amplifier connected to the digital arbitrary waveform generator.

An additional embodiment provides an apparatus for generating an arbitrary current waveform. The apparatus is comprised of: means for providing an arbitrary voltage waveform as an input to a test circuit; means for examining a current and voltage at an output of a device under test; means for sweeping a frequency through a predetermined range; and means for changing the frequency of the arbitrary voltage waveform to match a predetermined frequency and impedance point.

A further embodiment provides an apparatus for generating an arbitrary current waveform. The apparatus includes: means for providing an arbitrary voltage waveform as an input to a test circuit; means for examining a current and a voltage at an output of a device under test; means for sweeping a frequency through a predetermined range; means for collecting voltage and current values at pre-selected frequencies within a desired range; and means for repeating the collection process to produce an impedance over frequency plot for the test circuit.

Yet a further embodiment provides a machine readable non-transitory computer readable medium containing instructions, which when executed by a processor, cause the processor to perform the steps of: providing an arbitrary voltage waveform as an input to a test circuit; examining a current and voltage at an output of a device under test; sweeping a frequency through a predetermined range; and changing the frequency of the arbitrary voltage waveform to match a predetermined frequency and impedance point.

A yet further embodiment provides a machine readable non-transitory computer readable medium comprising instructions, which when executed by a processor cause the processor to perform the steps of: providing an arbitrary voltage waveform as an input to a test circuit; examining a current and a voltage at an output of a device under test; sweeping a frequency through a predetermined range; collecting voltage and current values at pre-selected frequencies within a desired range; and repeating the collection process to produce an impedance over frequency plot for the test circuit.

### BRIEF DESCRIPTION OF THE DRAWINGS

FIG. 1 illustrates is a block diagram of an apparatus for characterizing the impedance of a PDN with an active power supply according to an embodiment.

FIG. 2 illustrates the frequency range of an apparatus for characterizing the impedance of a PDN with an active power supply according to an embodiment.

FIG. 3 depicts a PMIC impedance characterized using an embodiment.

FIG. 4 is a flowchart of a method for generating an arbitrary current waveform according to an embodiment.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used in this application, the terms “component,” “module,” “system” and the like are intended to include a computer-related entity, such as, but not limited to hardware, firmware, a combination of hardware and software, software, or software in execution. For example, a component may be, but is not limited to being, a process running on a processor, a processor, an object, an executable, a thread of execution, a program and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Moreover, the term “or” is intended to man an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Embodiments described herein provide a circuit and a method of making impedance measurements of a power supply. The measurements are made at the system level. The measurement system consists of an electronic load which is used to produce a predetermined current pattern at the terminals of the power supply being tested. The electronic load is a feedback circuit that produces a known voltage pattern across a fixed resistor. The load current is produced independently of the power supply being tested.

The test configuration is used to produce a single tone load current and then measure the corresponding voltage at the terminals of the power supply under test. The ratio of this voltage and current provides the magnitude of the impedance and the phase difference between the current and voltage waveforms provides the angle of the impedance at a particular frequency. As configured, the circuit is not affected by the fact that modern power supplies do not have a linear relationship between voltage and current. This lack of a linear relationship between voltage and current allows production of an impedance model for a power supply that may not have an equivalent linear circuit.

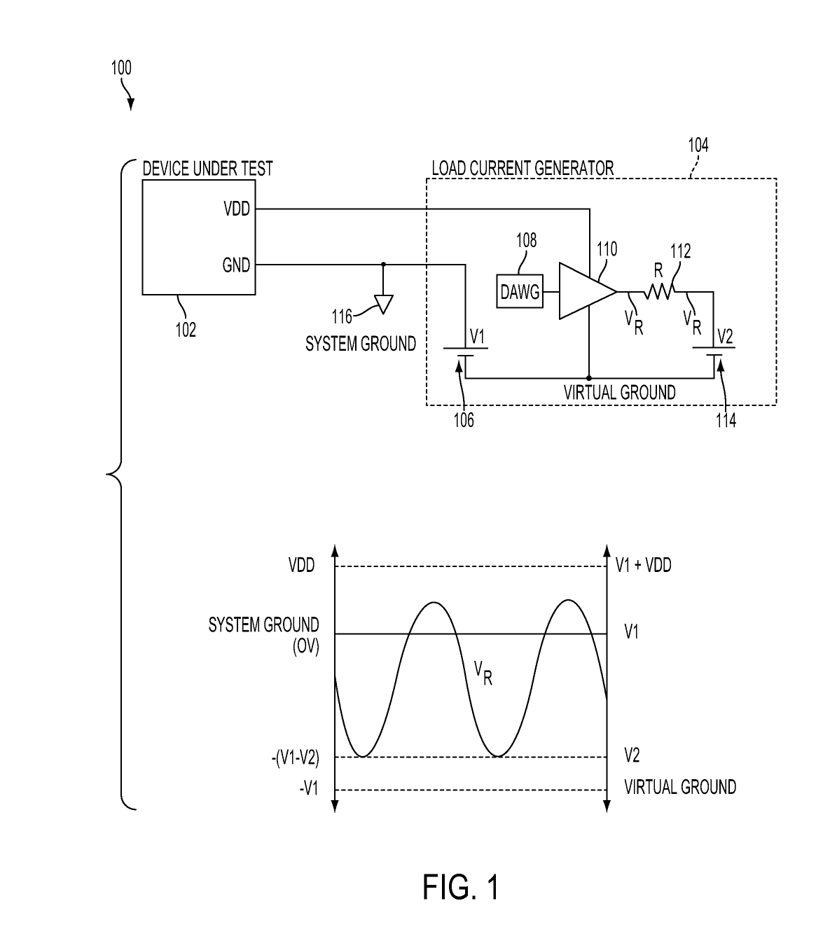

FIG. 1 illustrates in block diagram form the components of an embodiment for characterizing a PDN with an active power supply. The apparatus 100 includes a device under test 102 and a load current generator 104. Load current generator 104 includes batteries V1, 106 and V2 114, as well as a digital arbitrary waveform generator (DAWG) 108 and power amplifier 110. A variable resistor 112 is placed between the output of the power amplifier 110 and battery V2, 114.

System ground 116 is located between the device under test 102 and the load current generator 104.

The amplifier in FIG. 1, item 110 has a voltage across it. An embodiment described herein is used for analyzing power supplies, and does so by producing a large arbitrary sinusoidal current, as is illustrated in FIG. 1. For most testing purposes, the current need not be sinusoidal and any arbitrary current may be used. The embodiment depicted in FIG. 1 is capable of producing large sinusoidal load currents and may also produce other arbitrary load current wave forms as needed. An advantage of the embodiment illustrated in FIG. 1 is greater immunity from parasitics. In addition, the embodiment has the ability to produce large-signal sinusoidal load current as well as other arbitrary load current waveforms as needed. The method is applicable to any product with stringent power delivery network requirements and works reliable from DC to a few hundred KHZ. This range covers the frequency range of the PDN where the power supply is dominant.

The power delivery network includes a power management integrated circuit (PMIC). A printed circuit board (PCB) and a local de-coupling capacitor as found in most PMICs does not function as well as the embodiment shown in FIG. 1 because the area tested is the most non-linear segment of the power delivery network. While simulation may be more accurate, it does not give the best picture of the power delivery network.

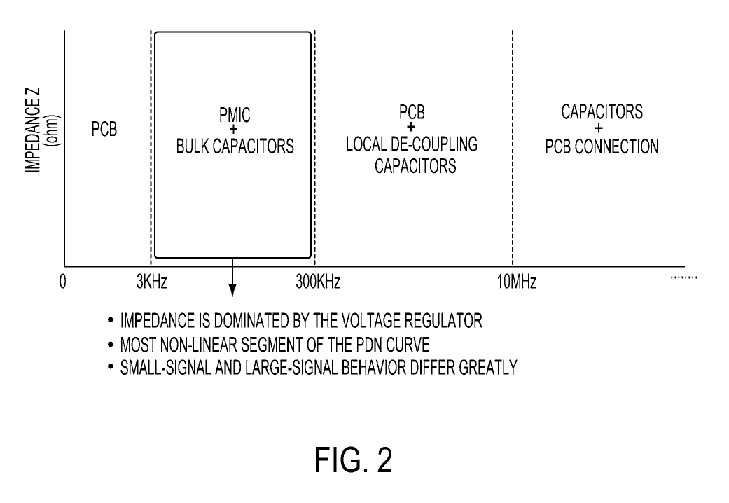

FIG. 2 shows the frequency range of operation of the embodiment illustrated in FIG. 1. In the frequency range of the invention, the impedance is dominated by the voltage regulator. This are is the most non-linear segment of the PDN curve and small-signal and large-signal behavior differ significantly.

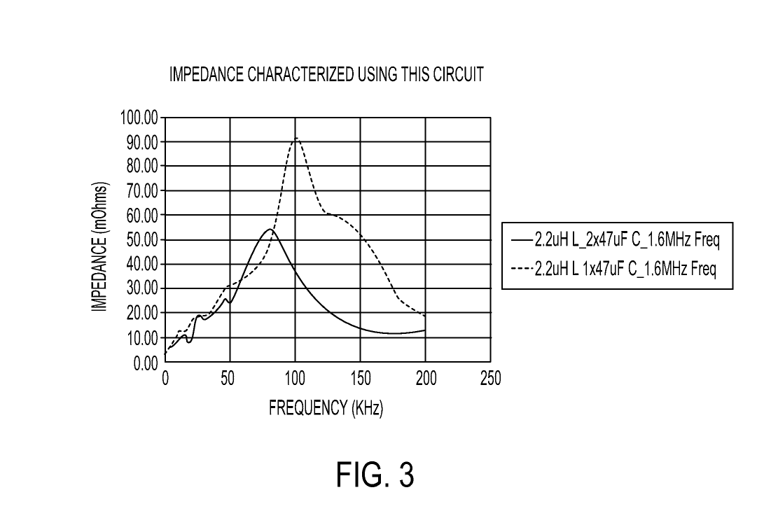

FIG. 3 illustrates a PMIC impedance characterized using an embodiment described herein. The device under test may be the PDN network and an arbitrary load may be used as an alternative to the arbitrary voltage waveform. In an embodiment, the current shape does not change, even though the current is very non-linear, because the current is not drawn from the function generator.

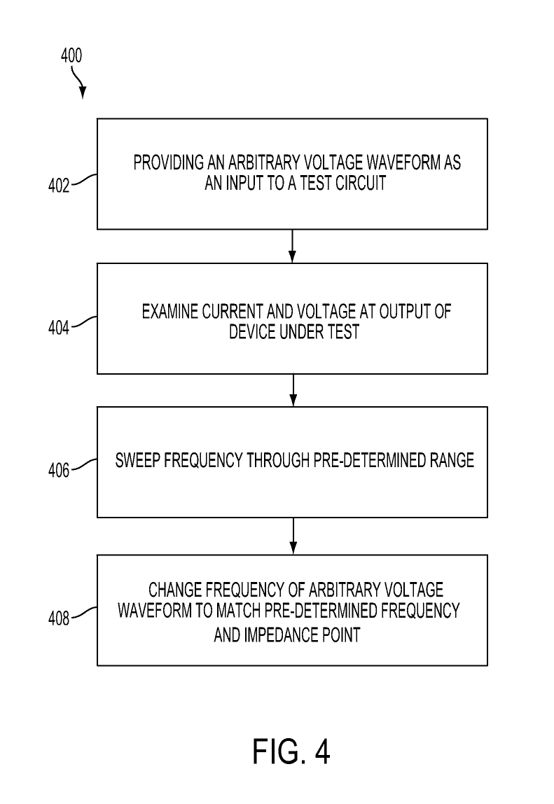

FIG. 4 provides a flowchart of a method for generating an arbitrary current waveform according to an embodiment. The method 400 beginning with step 402 where an arbitrary voltage waveform is provided as an input to a test circuit. In step 404 the current and voltage of the device under test are examined at an output of the device under test. The frequency is then swept through a pre-determined frequency range in step 406. The frequency of the arbitrary voltage wave form is changed to match the pre-determined frequency and impedance point in step 408, after which the method concludes.

The method described above and illustrated in FIG. 4 may be used with processors having PDN optimized load profiles. The processors may have a circuit incorporated into the ASIC for use by self-calibrating PDNs. Alternatively; the PDN may be characterized separately and input to the ASIC in the form of a look-up table. The method may also be used for characterizing voltage regulators and for emulating load currents for testing.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for generating an arbitrary current waveform, comprising:
providing an arbitrary voltage waveform as an input to a test circuit;
examining a current and voltage at an output of a device under test;
sweeping a frequency through a pre-determined range; and
changing the frequency of the arbitrary voltage waveform to match a pre-determined frequency and impedance point.

2. The method of claim 1, further comprising:
determining a magnitude of an impedance; and
determining an angle of the impedance.

3. The method of claim 2, wherein determining the impedance is performed by determining a ratio of the voltage and current at terminals of a power supply being tested.

4. The method of claim 2, wherein an angle of the impedance is determined using a phase difference between the voltage and current waveforms at a selected frequency.

5. A method for generating an arbitrary current waveform, comprising:
providing an arbitrary voltage waveform as an input to a test circuit;
examining a current and a voltage at an output of a device under test;
sweeping a frequency through a pre-determined range;
collecting voltage and current values at pre-selected frequencies within a desired range; and
repeating the collection to produce an impedance over frequency plot for the test circuit.

6. The method of claim 1, where the device under test exhibits non-linear behavior.

7. The method of claim 5, where the device under test exhibits non-linear behavior.

8. An apparatus for generating an arbitrary current waveform, comprising:
a load current generator, wherein the load current generator comprises:
a first battery connected to a ground of a device under test, a system ground, and a second battery;
a variable resistor;
a virtual ground; and
a power amplifier connected to the digital arbitrary waveform generator and the variable resistor.

9. An apparatus for generating an arbitrary current waveform, comprising:
means for providing an arbitrary voltage waveform as an input to a test circuit;
means for examining a current and voltage at an output of a device under test;
means for sweeping a frequency through a pre-determined range; and
means for changing the frequency of the arbitrary voltage waveform to match a pre-determined frequency and impedance point.

10. An apparatus for generating an arbitrary current waveform, comprising:
means for providing an arbitrary voltage waveform as an input to a test circuit;
means for examining a current and a voltage at an output of a device under test;
means for sweeping a frequency through a pre-determined range;
means for collecting voltage and current values at pre-selected frequencies within a desired range; and
means for repeating the collection to produce an impedance over frequency plot for the test circuit.

11. A machine readable non-transitory computer readable medium containing instructions, which when executed by a processor cause the processor to perform the steps of:
providing an arbitrary voltage waveform as an input to a test circuit;
examining a current and voltage at an output of a device under test;
sweeping a frequency through a pre-determined range; and
changing the frequency of the arbitrary voltage waveform to match a pre-determined frequency and impedance point.

12. The machine readable non-transitory computer readable medium of claim 11, further comprising instructions for:
determining a magnitude of an impedance; and
determining an angle of the impedance.

13. The machine readable non-transitory computer readable medium of claim 12, further comprising instruction for:
determining an angle of the impedance using a phase difference between the voltage and current waveforms at a selected frequency.

14. The machine readable non-transitory computer readable medium of claim 12, further comprising instructions for:
determining an angle of the impedance using a phase difference between the voltage and current waveforms at a selected frequency.

15. A machine readable non-transitory computer readable medium comprising instructions, which when executed by a processor cause the processor to perform the steps of:
providing an arbitrary voltage waveform as an input to a test circuit;
examining a current and a voltage at an output of a device under test;
sweeping a frequency through a pre-determined range;
collecting voltage and current values at pre-selected frequencies within a desired range; and
repeating the collection to produce an impedance over frequency plot for the test circuit.
